(19) United States
(12) Patent Application Publication
(10) Pub. No.: US 2004/0212805 A1
(43) Pub. Date: Oct. 28, 2004

(54) Optical input device capable of determining properties of a reflective plane

(75) Inventors: Ching-Pin Wang, Taipei City (TW); Li-Wen Tseng, Kaohsiung County (TW)

Correspondence Address: BACON & THOMAS, PLLC, 625 SLATERS LANE, FOURTH FLOOR, ALEXANDRIA, VA, 22314

(73) Assignee: Sunplus Technology Co., Ltd., Hsin-Chu (TW)

(21) Appl. No.: 10/687,670

(22) Filed: Oct. 20, 2003

(30) Foreign Application Priority Data
Apr. 23, 2003 (TW) 92206445

(51) Int. Cl. G01N 21/55

(52) U.S. Cl. 356/445

(57) ABSTRACT

An optical input device capable of determining properties of a reflective plane is disclosed. The optical input device applies a light device to project an incident light to the reflective plane. In accordance with the law of reflection, the incident light projected on the reflective plane produces reflecting light, diffusing light and transmitting light, respectively. The optical input device includes a first photosensor, a second photosensor and a microprocessor. The first photosensor receives a part of diffusing light to accordingly compute a total diffusing light. The second photosensor senses reflecting light. The microprocessor computes energy of the transmitting light in accordance with the law of energy conservation and accordingly determines if transmitting light consisting of light beams passes through the reflective plane. If yes, the reflective plane is determined to be formed of a transparent material, otherwise, it is determined to be formed of an opaque material.

### BACKGROUND OF THE INVENTION

1. Field of the Invention

The present invention relates to a technical field adapted for optical input apparatus and, more particularly, to an optical input device capable of determining properties of a reflective plane.

2. Description of Related Art

In input apparatus for typical optical mouse techniques, the operation principle essentially determines motions of an optical mouse by judging an uneven or micro-scraggy surface of a use plane (for example, a desk surface or a mouse pad). When the optical mouse is applied to planes formed of different materials, a photosensor implemented in the optical mouse will control appropriate photoelectric signal generation according to exposure time and gains.

However, when the optical mouse is applied to a transparent plane formed of material such as glass, the amount of reflecting light reflected by the transparent plane that can be received by the photosensor is nearly zero because incident light projected by a light device of the typical optical mouse almost totally passes through the glass. This results in no appropriate photoelectric signal generation for mouse operation control, so the capability of determining mouse motions is significantly reduced and thus is inconvenient in use. Therefore, it is desirable to provide an improved input device to mitigate and/or obviate the aforementioned problems.

### SUMMARY OF THE INVENTION

An object of the present invention is to provide an optical input device capable of determining properties of a reflective plane, which can determine if the reflective plane is a transparent plane and switch a corresponding optical mouse to an appropriate use mode according to properties of the reflective plane, thereby increasing use adaptability and flexibility of the optical mouse.

To achieve the object, the optical input device capable of determining properties of a reflective plane of the present invention essentially includes a light device, a first photosensor, a second photosensor and a microprocessor. The light device projects an incident light onto a reflective plane. The first photosensor receives diffusing light produced on the reflective plane by the incident light to compute a total diffusing light, and accordingly determines an uneven and micro-scraggy surface of the reflective plane to find distance and direction moved by the optical input device. The second photosensor senses reflecting light produced on the reflective plane by the incident light. According to values of the total diffusing light, the reflecting light and the incident light, the microprocessor computes a value of transmitting light produced when the incident light passes through the reflective plane and accordingly determines properties of the reflective plane.

Other objects, advantages, and novel properties of the invention will become more apparent from the following detailed description when taken in conjunction with the accompanying drawings.

### BRIEF DESCRIPTION OF THE DRAWINGS

FIG. 1 is a cross-section of interior of an optical mouse with an embodiment of the present invention; and

FIG. 2 is a schematic diagram of imaging produced after an incident light enters into an optical mechanism of FIG. 1.

### DETAILED DESCRIPTION OF THE PREFERRED EMBODIMENT

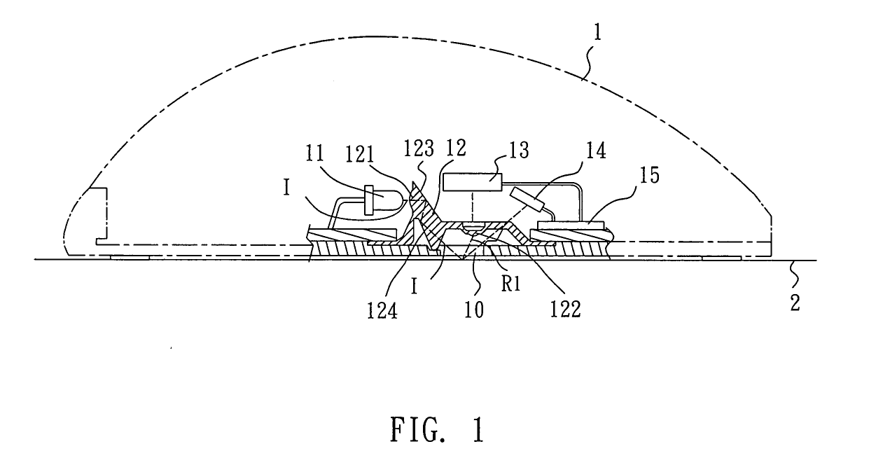

With reference to FIG. 1, an embodiment of the invention is shown. In FIG. 1, an optical input device is preferably an optical mouse 1 having a bottom opening 10 disposed in its bottom. The optical mouse 1 is internally formed of a light device 11, a light guiding device 12, a first photosensor 13, a second photosensor 14 and a microprocessor 15. The light device 11 is preferably a light emitting diode (LED) die or the like.

As shown in FIG. 1, the light device 11 emits an incident light source 11, which is parallel to a reflective plane 2 and projected exactly to a first lens 121 of the light guiding device 12. The incident light is focused by the first lens 121 and then reflected by a first prism 123 and a second prism 124 to accurately guide the incident light through the bottom opening 10 and project onto the reflective plane 2. It is noted that the light device 11 can be disposed above the light guiding device 12 as appropriately adjusted in design in order to profit incident light I received and projected into the reflective plane 2. Of course, the light device 11 can be disposed obliquely in the optical mouse 1 to profit the incident light I directly (or after being focused by the lens) projected onto the reflective plane 2.

In accordance with the law of reflection, when the incident light I₁ is projected to the reflective plane 2, a reflective light R1 is produced on the reflective plane 2. An included angle produced by the incident light I and the reflective plane 2 is equal to that produced by the reflective light R1 and the reflective plane 2. In addition, according to the principle of optical diffusion, when the incident light I₁ reaches the reflective plane 2, in addition the reflective light R1, Lambertian is produced in different levels depending on different materials used for the reflective plane 2. For example, when the reflective plane 2 is a mirror, the incident light I is totally reflected to produce the reflective light R1, without (or with little) diffusing light; when the reflective plane 2 is a rough plane with white MgO, the incident light is completely diffused; and when the reflective plane 2 is transparent (for example, formed of glass material), part of the incident light will pass through the reflective plane 2 to form transmitting light.

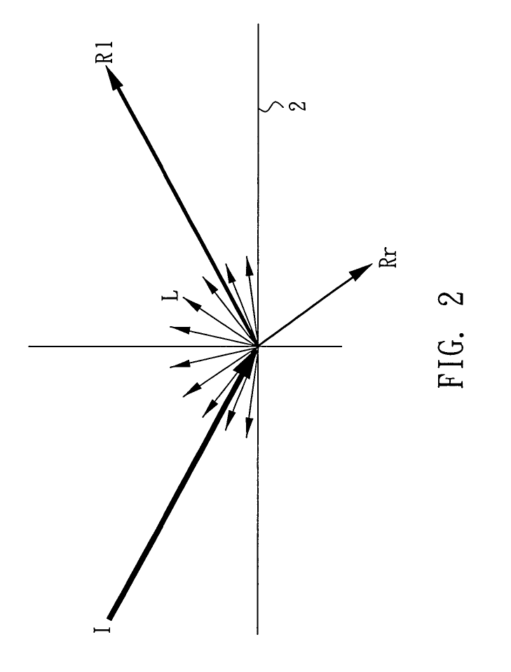

FIG. 2 shows a schematic diagram wherein reflecting light R1, transmitting light Rr and diffusing light L are respectively produced when the incident light I is projected to the reflective plane 2. As shown in FIG. 2, a reflective light R1 is formed on the reflective plane 2 by the incident light I, a plurality of beams of diffusing light are formed on the reflective plane 2 and scattered randomly, and part of the incident light I can pass through the reflective plane 2 to form the transmitting light Rr. The first photosensor 13 is disposed above the opening 10 to receive part of diffusing light L projected to the first photosensor 13 after being focused by the second lens 122 and compute a total f(L) of the energy of diffusing light L according to the complete mathematical model of Lambertian. The second photosensor 14 is disposed on a path of reflecting light R1 corresponding to the incident light I projected by the light device 11, in order to receive and compute the energy of reflecting light R1. The second lens 122 is coaxially disposed with the first photosensor 13.

According to the law of energy conservation, the microprocessor 15 can compute the energy of transmitting light Rr by the following equation:

Rr=I−R1−f(L),

where Rr is the transmitting light, I is the incident light, R1 is the reflecting light, f(L) is the total diffusing light.

The energy of transmitting light Rr greater than zero indicates that the reflective plane 2 is formed of a transparent material. In this case, almost all of the incident light I projected by the light device 11 of the optical mouse 1 passes through the reflective plane 2, so reflective light R1 reflected by the reflective plane 2 and received by the first photosensor 13 is nearly zero. Therefore, the optical mouse 1 can not easily produce appropriate photoelectric signals to control its operations in case of receiving finite reflecting light. At this point, the microprocessor 15 activates required means to switch the optical mouse 1 to a mode appropriate to operate on the reflective plane 2 formed of the transparent material. The energy of transmitting light Rr equal to zero indicates that the reflective plane 2 is formed of an opaque material. At this point, the first photosensor 13 of the optical mouse 1 can directly determine an uneven and micro-scraggy surface of the reflective plane 2 by means of diffusing light L, i.e., computation of a ratio of reflecting light R1 to total diffusing light f(L) to obtain roughness of the reflective plane 2 and thus determine corresponding distance and direction traveled by the optical mouse 1.

While the first photosensor is disposed in the optical input device to sense diffusing light, the second photosensor is added in the path of reflecting light to sense reflecting light and the energy of transmitting light is computed in accordance with the law of energy conservation, the optical input device can automatically determine property and roughness of a reflective plane based on the energy of transmitting light computed, to switch the optical input device to an appropriate use mode. Therefore, the optical input device's application is relatively increased and the use flexibility and convenience is achieved.

Although the present invention has been explained in relation to its preferred embodiment, it is to be understood that many other possible modifications and variations can be made without departing from the spirit and scope of the invention as hereinafter claimed.

What is claimed is:

1. An optical input device capable of determining properties of a reflective plane, comprising:
a light device, to project an incident light onto a reflective plane;
a first photosensor, to receive diffusing light produced on the reflective plane by the incident light, compute a total diffusing light and accordingly determine unevenness and micro-scragginess of the reflective plane to find distance and direction moved by the optical input device;
a second photosensor, to sense reflecting light produced on the reflective plane by the incident light; and
a microprocessor, to compute a value of transmitting light produced when the incident light passes through the reflective plane and accordingly determines properties of the reflective plane according to values of the total diffusing light, the reflecting light and the incident light.

2. The optical input device as claimed in claim 1, wherein the microprocessor computes the value of transmitting light based on the following equation:
Rr=I−R1−f(L),
where Rr is the transmitting light, I is the incident light, RI is the reflecting light, f(L) is the total diffusing light.

3. The optical input device as claimed in claim 1, wherein the optical input device is an optical mouse.

4. The optical input device as claimed in claim 3, wherein the optical input device has an opening in a bottom of the optical input device such that the incident light is projected to the reflective plane through the opening.

5. The optical input device as claimed in claim 4, wherein the first photosensor is disposed above the opening.

6. The optical input device as claimed in claim 1, wherein the second photosensor is disposed in a path corresponding to the reflecting light projected by the light device.

7. The optical input device as claimed in claim 1, wherein the light device is a light emitting diode (LED) die.
